(19) United States
(12) Patent Application Publication
(10) Pub. No.: US 2025/0093256 A1
(43) Pub. Date: Mar. 20, 2025

(54) DEVICE FOR FABRICATING SPECIMEN FOR TESTING ADHESIVE FORCE OF ELECTRODE ACTIVE MATERIAL LAYER AND METHOD FOR FABRICATING SPECIMEN FOR TESTING ADHESIVE FORCE OF ELECTRODE ACTIVE MATERIAL LAYER BY USING SAME

(71) Applicant: LG ENERGY SOLUTION, LTD., Seoul (KR)

(72) Inventor: Daehee CHO, Daejeon (KR)

(73) Assignee: LG ENERGY SOLUTION, LTD., Seoul (KR)

(21) Appl. No.: 18/728,836

(22) PCT Filed: May 24, 2023
(86) PCT No.: PCT/KR2023/007041

§ 371 Date: Jul. 12, 2024

(30) Foreign Application Priority Data
Jun. 21, 2022 (KR) 10-2022-0075353

(51) Int. Cl. G01N 19/04; H01M 4/02

(52) U.S. Cl. CPC G01N 19/04; H01M 4/02; H01M 2004/021

(57) ABSTRACT

A device used for fabricating a specimen for testing an adhesive force between an electrode active material layer and a current collector may include a lower guide panel having a guide groove on an upper surface of the lower guide panel. The guide groove may guide and accommodate a fixing substrate to which the electrode active material layer is adhered. The device may also include an upper guide panel having a guide hole for guiding an adhesion position of the electrode active material layer to the fixing substrate accommodated in the guide groove. The upper guide panel may be provided with a coupler for the upper portion of the lower guide panel. A method is also disclosed for fabricating the specimen using the device.

### CROSS-REFERENCE TO RELATED APPLICATIONS

The present application is a U.S. National Stage of PCT International Application No. PCT/KR2023/007041, filed on May 24, 2023, which claims the benefit of and priority to Korean Patent Application No. 10-2022-0075353, filed on Jun. 21, 2022, the entire contents of each of which are incorporated herein by reference.

### TECHNICAL FIELD

The present invention relates to a device for fabricating a specimen for testing the adhesive force of an electrode active material layer and a method for fabricating the specimen for testing the adhesive force of the electrode active material layer using the same.

### BACKGROUND ART

As the demand for mobile devices, electric vehicles, etc. is increased, the demand for secondary batteries is rapidly increasing. In particular, among secondary batteries, a lithium secondary battery having high energy density and voltage is commercialized and widely used.

Such a lithium secondary battery has a structure in which an electrode assembly capable of charging and discharging in a positive electrode/separator/negative electrode structure is mounted on a battery case.

The positive electrode and the negative electrode are manufactured by coating or bonding an active material to a current collector to form an active material layer. For example, they are manufactured by mixing an active material, a binder, and an electrically conductive material in a solvent to prepare a slurry, applying the obtained slurry to the current collector, drying it, and rolling it, or are manufactured by adhering an active material previously prepared in the form of a free-standing film by a dry or wet process to a current collector using an adhesive or the like.

If the active material layer is not firmly adhered to the current collector, there may be a problem that the active material layer may peel off due to the stress caused by the volume expansion and decrease of the electrode during the charging and discharging process, and the active material comes off easily even by the momentary pressure at the time of cutting during the process of cutting the electrode. Accordingly, the adhesive state of the active material layer to the current collector plays an important role in the performance of the battery, and to confirm this, a test is being conducted to evaluate the adhesive force of the active material layer.

The measurement of the adhesive force on the current collector of the active material layer is performed by adhering the electrode active material layer to a fixing substrate (e.g., glass substrate) and measuring the adhesive strength while removing the current collector by pulling it in the opposite direction. In this case, if the electrode active material layer of the specimen is not adhered to the correct position of the fixing substrate, accurate measurement results cannot be obtained.

However, the process of attaching the electrode active material layer of the specimen to the fixing substrate is performed manually, and due to this, it is frequently the case that the active material layer adheres obliquely onto the fixing substrate, resulting in poorly fabricated specimens. In addition, there is a problem even in the accuracy of adhesive force measurement accordingly.

### PRIOR ART DOCUMENT

### Patent Document

Korean Laid-open Utility Model Publication No. 20-2011-0000143

### DISCLOSURE

### Technical Problem

The present invention was made to solve the above problems of the prior art, and thus it is an object of the present invention to provide a device for fabricating a specimen for testing the adhesive force of an electrode active material layer, which can easily and quickly fabricate a highly reliable specimen by accurately guiding the adhesion position of the active material layer and the fixing substrate when fabricating a specimen for testing the adhesive force of the electrode active material layer.

In addition, it is another object of the present invention to provide a method for easily and quickly fabricating a specimen for testing the adhesive force of an electrode active material layer, which has high reliability, using the device for fabricating the specimen.

### Technical Solution

In order to achieve the above objects, the present invention provides
a device for fabricating a specimen for testing the adhesive force of the electrode active material layer, which comprises
a lower guide panel having a guide groove provided on its upper surface wherein the guide groove guides and accommodates a fixing substrate to which the electrode active material layer is adhered; and
an upper guide panel having a guide hole for guiding the adhesion position of the electrode active material layer to the fixing substrate accommodated in the guide groove,
wherein at least one of the upper guide panel and the lower guide panel is provided with a coupling means between the upper guide panel and the lower guide panel.

In one embodiment of the present invention, the upper guide panel exists in a form separated from the lower guide panel, and is provided in a form coupled to the lower guide panel when guiding the electrode active material layer; or may be provided in a form in which part or all of it is fixed to the lower guide panel.

In one embodiment of the present invention, the upper guide panel may be fixed to one side of the lower guide panel by a hinge.

In one embodiment of the present invention, the upper guide panel may be coupled in a structure in which it slides in the transverse direction on the upper surface of the lower guide panel, any one of the upper guide panel or the lower guide panel may be provided with a guide rail, and any one of the upper guide panel or the lower guide panel may be provided with a driving unit that slides on the guide rail.

In one embodiment of the present invention, in order to hold the fixing substrate accommodated in the guide groove, any one or more of the length or width of the guide hole may be smaller than the corresponding length or width of the guide groove.

In one embodiment of the present invention, the guide groove may be in the form of a square pillar with an open upper surface or in the form of a square pillar in which the upper surface and one side wall are open.

In one embodiment of the present invention, the guide hole may be in the form of a square pillar with an open upper or lower surface or in the form of a square pillar with an open upper or lower surface and one side wall.

In one embodiment of the present invention, one open side wall of the guide groove and the guide hole may be formed in the same direction.

In one embodiment of the present invention, the upper guide panel may be a transparent panel.

In addition, the present invention provides
a method for fabricating the specimen for testing the adhesive force of the electrode active material layer, which comprises the steps of:
(a) positioning a fixing substrate in a guide groove provided on a lower guide panel;
(b) adhering the electrode active material layer to the upper surface of the fixing substrate through a guide hole provided in an upper guide panel; and
(c) separating the specimen for testing the adhesive force of the electrode active material layer from the apparatus for fabricating the specimen.

In one embodiment of the present invention, the method may further comprise a step of coupling the upper guide panel to an upper portion of the lower guide panel so that the guide hole and the guide groove overlap after step (a) above.

In one embodiment of the present invention, the present invention may further comprise a step of releasing the coupling to the upper portion of the lower guide panel of the upper guide panel before separating the specimen for testing the adhesive force of the electrode active material layer in step (c) above.

In one embodiment of the present invention, the present invention may further comprise a step of attaching the double-sided tape to the fixing substrate or the active material layer upon adhesion of the electrode active material layer in step (b) above.

### Advantageous Effects

The device for fabricating a specimen for testing the adhesive force of an electrode active material layer according to the present invention accurately guides the active material layer and the adhesion position of the fixing substrate during specimen fabrication, thereby enabling reliable specimen fabrication easily and quickly.

In addition, the method for fabricating the specimen for testing the adhesive force of the electrode active material layer makes it possible to easily and quickly fabricate a highly reliable specimen by using the device for fabricating the specimen.

### BRIEF DESCRIPTION OF THE DRAWINGS

FIG. 1 is a view schematically showing a device for fabricating a specimen for testing the adhesive force of an electrode active material layer as an embodiment of the present invention.

FIG. 2 is an exploded view showing a device for fabricating a specimen for testing the adhesive force of an electrode active material layer as an embodiment of the present invention.

FIGS. 3A to 3C are views schematically showing an embodiment of an electrode and a specimen for testing the adhesive force of an electrode active material layer comprising the same.

FIGS. 4A to 4F are views schematically showing a method for fabricating a specimen for testing the adhesive force of an electrode active material layer as an embodiment of the present invention.

FIGS. 5A to 5D are views schematically showing a method for fabricating a specimen for testing the adhesive force of an electrode active material layer as another embodiment of the present invention.

### MODES OF PRACTICE

Hereinafter, embodiments of the present invention will be described in detail with reference to the accompanying drawings so that those skilled in the art can easily carry out the present invention. However, the present invention may be embodied in many different forms and is not limited to the embodiments described herein. The same reference numerals have been assigned to like parts throughout the specification.

When it is mentioned that a certain component “is connected to, provided with, or installed on” another component, it should be understood that it may be directly connected to or installed on another component, but other components may exist in therebetween. On the other hand, it is mentioned that a certain component is “directly connected to or installed on” another component, it should be understood that there are no other components in the middle. Meanwhile, other expressions describing the relationship between the elements, such as “on the upper portion” and “directly on the upper portion” or “between” and “immediately between” or “neighboring to” and “directly neighboring to”, etc., should be interpreted similarly.

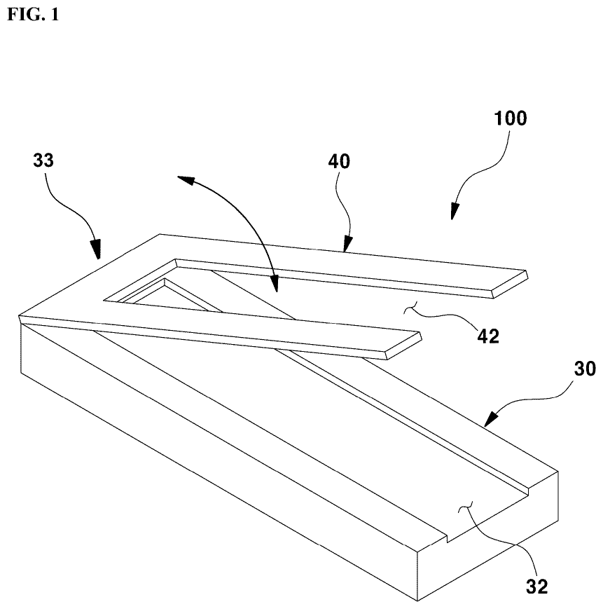

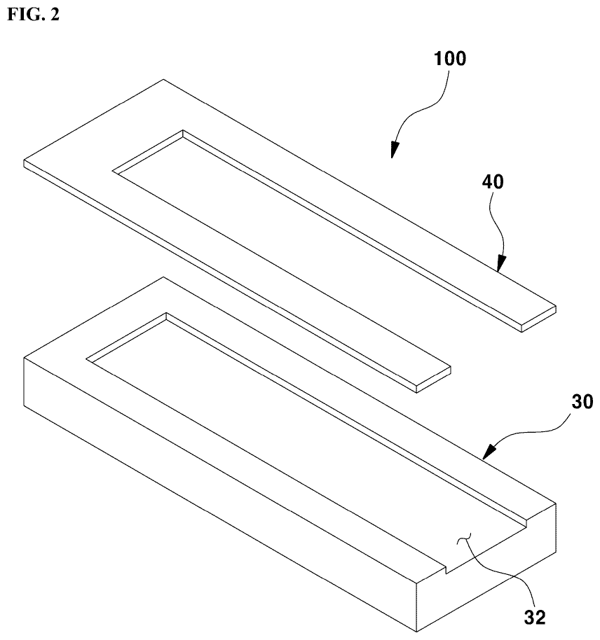

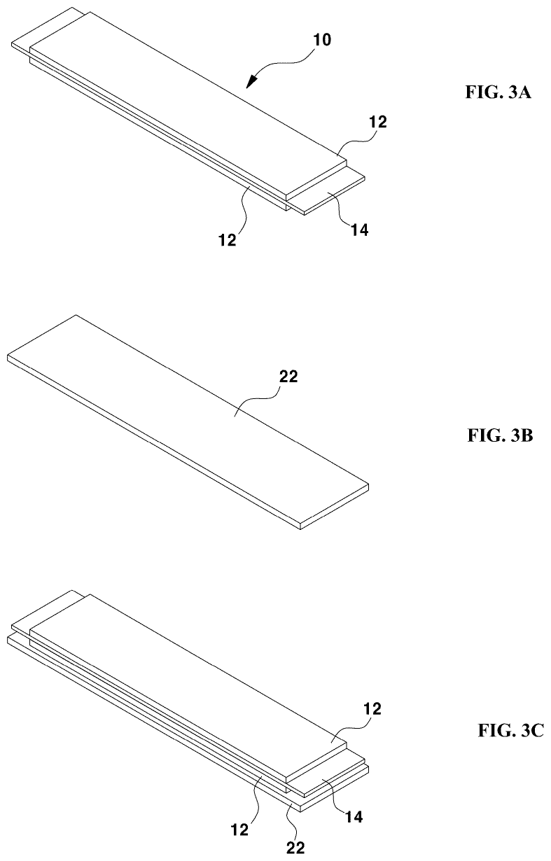

FIG. 1 is a view schematically showing a device 100 for fabricating a specimen for testing the adhesive force of an electrode active material layer as an embodiment of the present invention, FIG. 2 is an exploded view showing a device 100 for fabricating a specimen for testing the adhesive force of an electrode active material layer as an embodiment of the present invention, and FIGS. 3A to 3C are views schematically showing an embodiment of an electrode 10 and a specimen 20 for testing the adhesive force of an electrode active material layer including the same. Hereinafter, the present invention will be described with reference to the drawings.

The device 100 for fabricating a specimen for testing the adhesive force of an electrode active material layer of the present invention is a device used for the fabrication of specimen 20 for testing the adhesive force between the active material layer 12 of the electrode 10 and the current collector 14 (see FIG. 3A), comprising:
a lower guide panel 30 having a guide groove 32 provided on its upper surface wherein the guide groove guides and accommodates a fixing substrate 22 to which the electrode active material layer 12 is adhered; and
an upper guide panel 40 having a guide hole 42 for guiding the adhesion position of the electrode active material layer 12 to the fixing substrate 22 accommodated in the guide groove 32,
wherein any one or more of the upper guide panel 40 and the lower guide panel 30 is provided with a coupler 33 (or a coupling means) between the upper guide panel 40 and the lower guide panel 30.

In a lithium secondary battery, if the active material layer is not firmly adhered to the current collector, the active material layer may peel off due to the stress caused by the volume expansion and decrease of the electrode during the charging and discharging process, and there may be a problem that during the process of cutting the electrode, the active material comes off easily even by the momentary pressure at the time of cutting. Therefore, the adhesion state of the active material layer to the current collector plays an important role in the performance of the battery, and thus to confirm this, a test is being conducted to evaluate the adhesive force of the active material layer.

The measurement of the adhesive force on the current collector of the active material layer is performed by adhering the electrode active material layer to a fixing substrate (e.g., glass substrate) and measuring the adhesive strength while removing the current collector by pulling it in the opposite direction. In this case, if the electrode active material layer of the specimen is not adhered to the correct position of the fixing substrate, accurate measurement results cannot be obtained.

However, the process of attaching the electrode active material layer of the specimen to the fixing substrate is performed manually, and due to this, it is frequently the case that the active material layer adheres obliquely onto the fixing substrate, resulting in poorly fabricated specimens. In addition, there is a problem even in the accuracy of adhesive force measurement accordingly.

That is, the adhesive force measurement is performed using a UTM device after fabrication of the specimen 20 for testing the adhesive force of the electrode active material layer as shown in FIG. 3C. However, if the electrode active material layer 12 is not accurately attached to the position determined by matching the straightness and parallelism to the fixing substrate 22 constituting the specimen 20 for testing the adhesive force of the electrode active material layer, such inaccurate attachment causes a change in the value of the measured tensile force. Therefore, accurate fabrication of the specimen 20 for testing the adhesive force of the electrode active material layer is absolutely required for accurate measurement of the adhesive force on the current collector of the active material layer.

The device 100 for fabricating a specimen for testing the adhesive force of an electrode active material layer of the present invention provides the effect of easily and conveniently satisfying the conditions required for the specimen as described above. Therefore, according to the present invention, since the generation of incorrectly fabricated specimens is fundamentally prevented, a specimen with an accurate and uniform shape can be fabricated in a simple way, and thus the adhesive force on the current collector of the electrode active material layer can be easily and accurately measured.

The coupler 33 (or the above coupling means) is not particularly limited, and coupling means known in the art may be employed.

In one embodiment of the present invention, it does not matter what form the upper guide panel 40 is provided in the device 100 for fabricating a specimen for testing the adhesive force of an electrode active material layer as long as it is in a form that can be coupled to the lower guide panel 30 when guiding the electrode active material layer 12. For example, the upper guide panel 40 exists in a form separated from the lower guide panel 30, and is provided in a form coupled to the lower guide panel 30 when guiding the electrode active material layer 12; or may be provided in a form in which part or all of it is fixed to the lower guide panel 30.

If the upper guide panel 40 is provided in a form separated from the lower guide panel 30, it may be provided in a detachable structure on the upper surface of the lower guide panel 30 when guiding the electrode active material layer 12. In this case, as the detachable structure, structures known in the art may be applied without limitation. For example, a coupling fence for detaching the upper guide panel 40 may be provided on the outer circumference of the upper surface of the lower guide panel 30, or conversely, a coupling fence for detaching the lower guide panel 30 may be provided on the outer circumference of the lower surface of the upper guide panel 40. In addition, a coupling protrusion portion is provided on either the upper guide panel 40 or the lower guide panel 30, and a structure in which a coupling groove portion capable of accommodating the coupling protrusion portion is provided in either the upper guide panel 40 or the lower guide panel 30 is also possible.

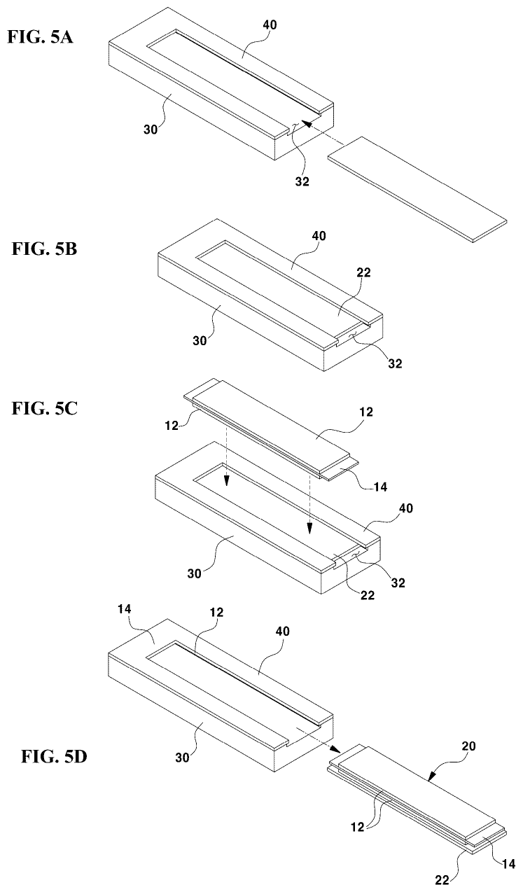

Among the cases in which the upper guide panel 40 is partially or entirely fixed to the lower guide panel 30, the case of the entirely fixed form, as shown in FIGS. 5A to 5D, is a case that the guide groove 32 of the lower guide panel 30 may be formed in a form into which the fixing substrate 22 can be inserted, even in the state where the upper guide panel 40 is entirely fixed. For example, when one side wall of the guide groove 32 has an open form, the fixing substrate 22 may be inserted through the open one side wall of the guide groove 32.

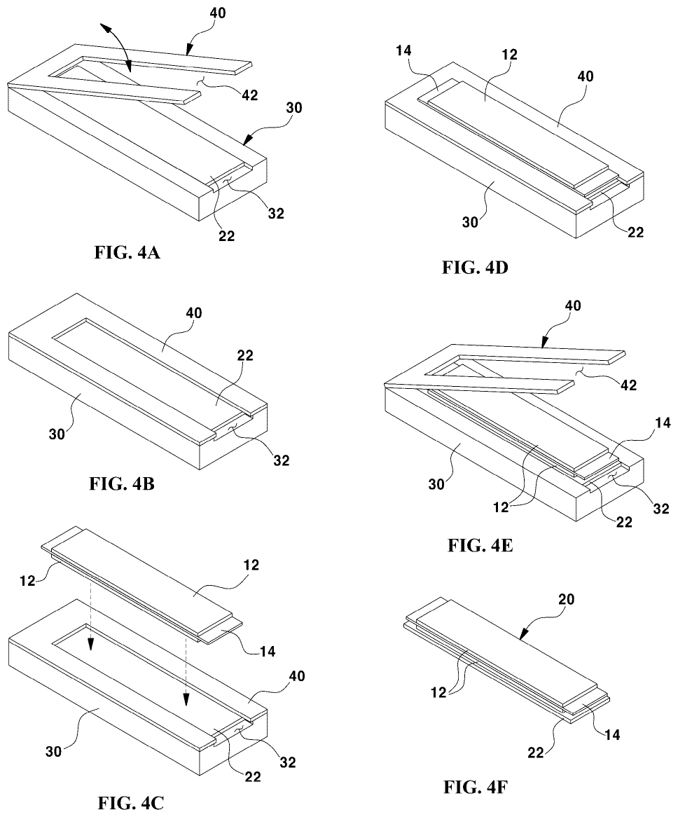

In addition, in the case of the partially fixed form, for example, as shown in FIG. 1, it may be mentioned that the upper guide panel 40 is fixed to one side of the lower guide panel 30 by a hinge. In this case, while the upper guide panel 40 behaves as shown in FIGS. 4A to 4F, fabrication of a specimen for testing the adhesive force of the electrode active material layer can be performed.

Also, for example, the upper guide panel 40 may be coupled in a structure in which the upper surface of the lower guide panel 30 slides in a transverse direction. In this case, a guide rail is provided on either the upper guide panel 40 or the lower guide panel 30, and a driving part that slides to either the upper guide panel 40 or the lower guide panel 30 on the guide rail may be provided.

Among the above structures, considering the fabrication convenience of the specimen for testing the adhesive force of the electrode active material layer, in particular, a form in which the upper guide panel 40 is fixed to one side of the lower guide panel 30 by a hinge may be preferable.

In one embodiment of the present invention, in order to hold the fixing substrate 22 accommodated in the guide groove 32, any one or more of the length or width of the guide hole 42 may be smaller than the corresponding length or width of the guide groove 32.

In one embodiment of the present invention, the guide groove 32 may be in the form of a square pillar with an open upper surface, and also the guide hole 42 may be in the form of a square pillar with open upper and lower surfaces.

In addition, the guide groove 32 may be in the form of a square pillar with an open upper surface and one side wall, and also the guide hole 42 may be in the form of a square pillar with an open upper and lower surface and one side wall.

Furthermore, one open side wall of the guide groove 32 and the guide hole 42 may be formed in the same direction as shown in FIG. 1. In addition, the same direction of the open one side wall may be a longitudinal direction of one side wall of the device for fabricating a specimen for testing the adhesive force of an electrode active material layer. In addition, when the upper guide panel 40 is fixed to one side of the lower guide panel 30 by a hinge, the one side wall in the longitudinal direction may be the opposite one side wall to which the hinge is fixed.

In one embodiment of the present invention, the upper guide panel 40 may be a transparent panel. When formed as a transparent panel as described above, since the visibility of the fixing substrate 22 or the like in the downward direction is improved, it may be preferable.

In one embodiment of the present invention, as the material of the upper guide panel 40, for example, acrylic resin may be used, but is not limited thereto. In this case, as described above, the upper guide panel 40 may be provided as a transparent panel.

As the material of the lower guide panel 30, a material resistant to heat and humidity environment can be preferably used. For example, a bakelite material may be used, but is not limited thereto.

In one embodiment of the present invention, the electrode 10 may have a form in which the current collector 14 and an active material layer 12 are stacked on one or more surfaces of the current collector. For example, the electrode 10 may have a form in which active material layers 12 are formed on both sides of the current collector 14 as shown in FIG. 3A.

In addition, the present invention provides a method for fabricating the specimen for testing the adhesive force of the electrode active material layer.

The method for fabricating the specimen is a method for fabricating a specimen 20 for testing the adhesive force of the electrode active material layer by using the device 100 for fabricating a specimen for testing the adhesive force of an electrode active material layer, which comprises the steps of,
(a) positioning the fixing substrate 22 on the guide groove 32 provided on the lower guide panel 30 (FIGS. 4A and 4B);
(b) adhering the electrode active material layer 12 to the upper surface of the fixing substrate 22 through the guide hole 42 provided in the upper guide panel 40 (FIGS. 4C and 4D); and
(c) separating the specimen 20 for testing the adhesive force of the electrode active material layer from the device 100 for fabricating the specimen 20 (FIGS. 4E and 4F).

In one embodiment of the present invention, the present invention may further comprise, after the step (a), a step of coupling the upper guide panel 40 to the upper portion of the lower guide panel 30 so that the guide hole 42 and the guide groove 32 overlap (FIGS. 4A and 4B).

In one embodiment of the present invention, the present invention may further comprise a step of releasing the coupling to the upper portion of the lower guide panel 30 of the upper guide panel 40 before separating the specimen 20 for testing the adhesive force of the electrode active material layer in step (c) above (FIG. 4E).

In one embodiment of the present invention, when adhering the electrode active material layer 12 in step (b), the adhering may be performed by a method known in the art. For example, it can be implemented by a method of applying an adhesive to the fixing substrate 22 or the active material layer 12 and adhering them, or a method of attaching a double-sided tape to the fixing substrate 22 or the active material layer 12.

Although the present invention has been described in relation to the above-mentioned preferred embodiments, it is possible to make various modifications and variations without departing from the spirit and scope of the invention. Accordingly, the appended claims will cover these modifications and variations insofar as they fall within the scope of the present invention.

[Description of Symbol]

| | |
|---|---|
| 10: Electrode | 12: Active material layer |
| 14: current collector | 20: Specimen for testing adhesive |
| | force of electrode active material |
| | layer |
| 22: Fixing substrate | 30: Lower guide panel |
| 32: Guide groove | 33: Coupler |
| 40: Upper guide panel | 42: Guide hole |
| 100: Device for fabricating specimen | |
| for testing adhesive force of electrode | |
| active material layer | |

1. A device for fabricating a specimen for testing an adhesive force of an electrode active material layer, the device comprising:
a lower guide panel having a guide groove provided on an upper surface of the lower guide panel, wherein the guide groove is configured to guide and accommodate a fixing substrate to which the electrode active material layer is adhered; and
an upper guide panel having a guide hole for guiding an adhesion position of the electrode active material layer to the fixing substrate accommodated in the guide groove,
wherein at least one of the upper guide panel and the lower guide panel is provided with a coupler between the upper guide panel and the lower guide panel.

2. The device for fabricating the specimen for testing the adhesive force of the electrode active material layer according to claim 1, wherein the upper guide panel is provided in a form separated from the lower guide panel or is provided in a form in which a part or all of the upper guide panel is fixed to the lower guide panel, wherein the upper guide panel separated from the lower guide panel is coupled to the lower guide panel when guiding the electrode active material layer.

3. The device for fabricating the specimen for testing the adhesive force of the electrode active material layer according to claim 2, wherein the upper guide panel is fixed to one side of the lower guide panel by a hinge.

4. The device for fabricating the specimen for testing the adhesive force of the electrode active material layer according to claim 2, wherein the upper guide panel is coupled in a structure in which it is configured to slide in a transverse direction on the upper surface of the lower guide panel, any one of the upper guide panel or the lower guide panel is provided with a guide rail, and the other one of the upper guide panel or the lower guide panel is provided with a driving unit that is configured to slide on the guide rail.

5. The device for fabricating the specimen for testing the adhesive force of the electrode active material layer according to claim 1, wherein any one or more of a length or a width of the guide hole is smaller than a corresponding length or width of the guide groove in order to hold the fixing substrate accommodated in the guide groove.

6. The device for fabricating the specimen for testing the adhesive force of the electrode active material layer according to claim 1, wherein the guide groove is in a form of a square pillar with an open upper surface or in a form of a square pillar in which the upper surface and one side wall of the guide groove are open.

7. The device for fabricating the specimen for testing the adhesive force of the electrode active material layer according to claim 6, wherein the guide hole is in a form of a square pillar with open upper and lower surfaces or in a form of a square pillar with open upper and lower surfaces and one side wall.

8. The device for fabricating the specimen for testing the adhesive force of the electrode active material layer according to claim 7, wherein one open side wall of the guide groove and the guide hole are formed in a same direction.

9. The device for fabricating the specimen for testing the adhesive force of the electrode active material layer according to claim 1, wherein the upper guide panel is a transparent panel.

10. A method for fabricating the specimen for testing the adhesive force of the electrode active material layer by using the device for fabricating the specimen according to claim 1, wherein the method comprises:
positioning the fixing substrate in the guide groove provided on the lower guide panel;
adhering the electrode active material layer to the upper surface of the fixing substrate through the guide hole provided in the upper guide panel; and
separating the specimen for testing the adhesive force of the electrode active material layer from the device for fabricating the specimen.

11. The method for fabricating the specimen for testing the adhesive force of the electrode active material layer according to claim 10, further comprising coupling the upper guide panel to an upper portion of the lower guide panel so that the guide hole and the guide groove overlap, after the positioning of the fixing substrate.

12. The method for fabricating the specimen for testing the adhesive force of the electrode active material layer according to claim 11, further comprising releasing the coupling of the upper guide panel to the upper portion of the lower guide panel before separating the specimen for testing the adhesive force of the electrode active material layer.

13. The method for fabricating the specimen for testing the adhesive force of the electrode active material layer according to claim 10, further comprising attaching a double-sided tape to the fixing substrate or the electrode active material layer upon adhesion of the electrode active material layer.
